(19) United States
(12) Patent Application Publication
(10) Pub. No.: US 2026/0322246 A1
(43) Pub. Date: Oct. 15, 2026

(54) SWITCHING POWER SUPPLY

(71) Applicant: DECO INTEGRATION TECHNOLOGY CO.,LIMITED, Shenzhen (CN)

(72) Inventors: Cheng LI, Shenzhen (CN); Weinian LIANG, Shenzhen (CN); Beizhou ZHUANG, Shenzhen (CN)

(73) Assignee: DECO INTEGRATION TECHNOLOGY CO.,LIMITED, Shenzhen (CN)

(21) Appl. No.: 19/444,398

(22) Filed: Jan. 9, 2026

Related U.S. Application Data
(63) Continuation of application No. PCT/CN2024/098936, filed on Jun. 13, 2024.

(30) Foreign Application Priority Data
Jul. 14, 2023 (CN) 202310869829.4

(51) Int. Cl. H02M 1/088; H01Q 5/20; H02M 1/00; H02M 1/32; H02M 1/44; H02M 7/217; H04B 1/48

(52) U.S. Cl. CPC H02M 1/088; H01Q 5/20; H02M 1/0012; H02M 1/32; H02M 1/44; H02M 7/2176; H04B 1/48

(57) ABSTRACT

The present invention discloses a switching power supply, comprising a primary-side control circuit, a secondary-side control circuit, a controller, and a millimeter wave transceiver, all integrated onto a single chip. The controller connects to the primary-side control circuit via the millimeter wave transceiver and is also connected to the secondary-side control circuit. The isolation provided by the millimeter wave transceiver ensures the required safety isolation distance between the primary and secondary sides, thereby achieving a fully integrated single-chip design. This monolithic design not only simplifies the circuitry and reduces the size of the power supply, but also lowers EMI interference. Moreover, control for the primary side is directly generated by the controller, with signals transmitted and received via the millimeter wave transceiver. This approach greatly improves the speed of signal transmission and reception, leading to low latency and high operational efficiency.

### RELATED APPLICATIONS

The present patent document is a continuation of PCT Application Serial No. PCT/CN2024/098936, filed Jun. 13, 2024, designating the United States and published in English, which is hereby incorporated by reference.

The present patent document claims the benefit of priority to Patent Application No. 202310869829.4, filed Jul. 14, 2023, and entitled “SWITCHING POWER SUPPLY,” the entire contents of each of which are incorporated herein by reference.

### BACKGROUND

### 1. Technical Field

The present invention relates to the field of electric energy conversion, and more particularly to a switching power supply.

### 2. Background Information

A switching power supply is a high-frequency electric energy conversion device that typically converts input AC power into a specific form of DC power for charging load equipment. By controlling the on and off states of the switch, the operating power of the power transformer is regulated to meet the requirements of circuits with different power demands. Switching power supplies are widely used in fields such as automation control, military equipment, scientific research equipment, LED lighting, industrial control equipment, communication equipment, and power equipment.

In existing switching power supplies, primary-side and secondary-side control are mostly implemented with discrete components. As shown in FIG. 1, the switching power supply includes a switching power supply chip at the primary side, a synchronous rectification chip at the secondary side, and a charging protocol chip. The discrete design among the switching power supply chip, the synchronous rectification chip, and the charging protocol chip is intended to meet the safety distance requirements of safety regulations. Therefore, the design of existing switching power supplies not only results in complex design and large size, but also leads to problems such as high EMI interference.

### BRIEF SUMMARY

The technical problem to be solved by the present invention is to provide a switching power supply, which achieves compact design while reducing EMI interference.

To solve the above technical problem, the present invention adopts the following the technical solution:

A switching power supply includes a primary-side control circuit and a secondary-side control circuit, further includes a controller and a millimeter wave transceiver.

The primary-side control circuit, the secondary-side control circuit, the controller, and the millimeter wave transceiver are integrated on a same chip.

The controller is connected to the primary-side control circuit via the millimeter wave transceiver.

The controller is connected to the secondary-side control circuit.

Further, the millimeter wave transceiver includes a millimeter wave transmitting circuit and a millimeter wave receiving circuit.

One end of the millimeter wave transmitting circuit is connected to the controller, and the other end is wirelessly connected to one end of the millimeter wave receiving circuit.

The other end of the millimeter wave receiving circuit is connected to the primary-side control circuit.

Further, the millimeter wave transceiver is a millimeter wave transceiver chip.

Further, the primary-side control circuit is a switching power supply chip.

Further, the primary-side control circuit includes a driver and a power transistor.

The controller is connected to an input terminal of the driver via the millimeter wave transceiver.

An output terminal of the driver is connected to the power transistor.

Further, the primary-side control circuit includes a logic control and fault protection circuit, an overvoltage protection circuit, and a regulator circuit.

The overvoltage protection circuit and the regulator circuit are respectively connected to the logic control and fault protection circuit.

The logic control and fault protection circuit is connected to the millimeter wave transceiver via the regulator circuit.

Further, the millimeter wave transceiver includes a millimeter wave transmitter, a millimeter wave receiver, a transmitting antenna, and a receiving antenna.

The logic control and fault protection circuit is connected to one end of the millimeter wave receiver via the regulator circuit, and the other end of the millimeter wave receiver is connected to the receiving antenna.

One end of the millimeter wave transmitter is connected to the controller, and the other end is connected to the transmitting antenna.

The transmitting antenna communicates with the receiving antenna via millimeter waves.

Further, the overvoltage protection circuit includes an AC overvoltage protection circuit, a brown-in/brown-out protection circuit, and an X capacitor discharge circuit.

The regulator circuit includes a first low dropout linear regulator circuit, a second low dropout linear regulator circuit, a third low dropout linear regulator circuit, and a VCC overvoltage protection circuit.

The millimeter wave receiver includes a signal output terminal, a receiving power supply terminal, and a receiving enable terminal.

An output terminal of the AC overvoltage protection circuit, an output terminal of the brown-in/brown-out protection circuit, an output terminal of the X capacitor discharge circuit, an output terminal of the first low dropout linear regulator circuit, and an output terminal of the VCC overvoltage protection circuit are all connected to an input terminal of the logic control and fault protection circuit.

An output terminal of the second low dropout linear regulator circuit is connected to a power input terminal of the power transistor.

A first enable terminal of the logic control and fault protection circuit is connected to a first input terminal of the third low dropout linear regulator circuit.

An output terminal of the third low dropout linear regulator circuit is connected to the receiving power supply terminal of the millimeter wave receiver.

The signal output terminal of the millimeter wave receiver is connected to the logic control and fault protection circuit via a first buffer.

A second enable terminal of the logic control and fault protection circuit is connected to the receiving enable terminal of the millimeter wave receiver.

Further, the switching power supply further includes an input control circuit.

The input control circuit is respectively connected to a drain of the power transistor, an input terminal of the AC overvoltage protection circuit, an input terminal of the brown-in/brown-out protection circuit, an input terminal of the X capacitor discharge circuit, an input terminal of the first low dropout linear regulator circuit, an input terminal of the VCC overvoltage protection circuit, an input terminal of the second low dropout linear regulator circuit, a second input terminal of the third low dropout linear regulator circuit, and the input terminal of the logic control and fault protection circuit.

Further, the primary-side control circuit further includes an RS flip-flop.

An S terminal and an R terminal of the RS flip-flop are both connected to the logic control and fault protection circuit, a Q terminal is connected to the input terminal of the driver, and the output terminal of the driver is connected to a gate of the power transistor.

Further, the primary-side control circuit further includes a negative voltage sampling circuit, a leading edge blanking circuit, a CS jitter correction circuit, a maximum frequency setting circuit, and a first comparator.

The input control circuit is connected to an input terminal of the negative voltage sampling circuit.

An output terminal of the negative voltage sampling circuit is connected to an input terminal of the leading edge blanking circuit.

An output terminal of the leading edge blanking circuit is respectively connected to an input terminal of the CS jitter correction circuit and an input terminal of the maximum frequency setting circuit.

An output terminal of the CS jitter correction circuit is connected to a positive terminal of the first comparator.

A negative terminal of the first comparator is connected to a first reference voltage.

An output terminal of the first comparator and an output terminal of the maximum frequency setting circuit are respectively connected to the logic control and fault protection circuit.

Further, the switching power supply further includes a transformer.

The input control circuit includes a rectifier bridge, a first diode, a second diode, a first resistor, a first electrolytic capacitor, a second resistor, a first capacitor, a third diode, a fourth diode, a third resistor, a second capacitor, and a fourth resistor.

One end of an AC input terminal of the rectifier bridge is connected to an anode of the first diode, and the other end is connected to an anode of the second diode.

A cathode of the first diode and a cathode of the second diode are both connected to one end of the first resistor, and the other end of the first resistor is respectively connected to the input terminal of the AC overvoltage protection circuit, the input terminal of the brown-in/brown-out protection circuit, and the input terminal of the X capacitor discharge circuit.

A primary side of the transformer includes a first winding and a second winding.

One end of a DC terminal of the rectifier bridge is grounded, and the other end is respectively connected to a heteronymous terminal of the first winding, one end of the second resistor, one end of the first capacitor, and one end of the first electrolytic capacitor.

The other end of the first electrolytic capacitor is connected to one end of the third resistor.

The other end of the third resistor is connected to the input terminal of the negative voltage sampling circuit.

The other end of the second resistor and the other end of the first capacitor are respectively connected to a cathode of the third diode.

An anode of the third diode is respectively connected to the drain of the power transistor and a homonymous terminal of the first winding.

A homonymous terminal of the second winding is connected to an anode of the fourth diode.

A cathode of the fourth diode is connected to one end of the fourth resistor.

The other end of the fourth resistor is respectively connected to the input terminal of the first low dropout linear regulator circuit, the input terminal of the VCC overvoltage protection circuit, the input terminal of the second low dropout linear regulator circuit, the second input terminal of the third low dropout linear regulator circuit, and one end of the second capacitor.

The other end of the second capacitor, a heteronymous terminal of the second winding, and a source of the power transistor are all grounded.

Further, the switching power supply further includes an output control circuit.

The output control circuit is respectively connected to a secondary side of the transformer and the secondary-side control circuit.

Further, the secondary-side control circuit includes a synchronous rectification circuit.

The controller is connected to the synchronous rectification circuit.

Further, the millimeter wave transmitter includes a signal input terminal, a transmitting power supply terminal, and a transmitting enable terminal.

The synchronous rectification circuit includes a detector, a regulator, a fourth low dropout linear regulator circuit, an external overtemperature protection circuit, a Schmitt trigger, a LATCH/auto recovery circuit, a second comparator, a third comparator, a NOR gate, a first AND gate, a first OR gate, and a first oscillator.

A first input terminal and a second input terminal of the detector, a first input terminal and an output terminal of the regulator, an input terminal and an output terminal of the fourth low dropout linear regulator circuit, a first output terminal of the external overtemperature protection circuit, a positive terminal of the Schmitt trigger, an input terminal of the LATCH/auto recovery circuit, a positive terminal of the second comparator, and a positive terminal of the third comparator are all connected to the output control circuit.

A first output terminal of the detector is connected to a second input terminal of the regulator, and the second output terminal is connected to the controller.

An input terminal of the external overtemperature protection circuit is connected to the controller.

An output terminal of the Schmitt trigger and an output terminal of the LATCH/auto recovery circuit are both connected to the controller.

An output terminal of the second comparator is connected to a first input terminal of the NOR gate.

An output terminal of the third comparator is connected to a second input terminal of the NOR gate.

An output terminal of the NOR gate is connected to a third input terminal of the first AND gate.

A first input terminal of the first AND gate is connected to a third output terminal of the detector.

A second input terminal of the first AND gate is connected to the controller.

A first output terminal and a second output terminal of the first oscillator are connected to a fourth input terminal and a fifth input terminal of the first AND gate.

A third output terminal of the first oscillator is connected to the controller.

A first input terminal of the first OR gate is connected to the controller.

An output terminal of the first AND gate is connected to a second input terminal of the first OR gate.

An output terminal of the first OR gate is connected to the signal input terminal of the millimeter wave transmitter.

An enable terminal of the controller is connected to the transmitting enable terminal of the millimeter wave transmitter.

The output terminal of the fourth low dropout linear regulator circuit is connected to the transmitting power supply terminal of the millimeter wave transmitter.

Further, the output control circuit includes a first transistor, a second electrolytic capacitor, a fifth resistor, a third capacitor, a fourth capacitor, a sixth resistor, a seventh resistor, and an eighth resistor.

The secondary side of the transformer includes a third winding.

A homonymous terminal of the third winding is respectively connected to one end of the second electrolytic capacitor, one end of the sixth resistor, the first input terminal of the detector, and the input terminal of the fourth low dropout linear regulator circuit.

The other end of the second electrolytic capacitor is respectively connected to a source of the first transistor, one end of the third capacitor, one end of the fourth capacitor, and one end of the eighth resistor, all of which are grounded.

The other end of the sixth resistor is respectively connected to one end of the seventh resistor and the positive terminal of the second comparator.

The other end of the seventh resistor is respectively connected to the other end of the eighth resistor and the positive terminal of the second comparator.

The other end of the third capacitor is respectively connected to the output terminal of the voltage regulator and the positive terminal of the Schmitt trigger.

The other end of the fourth capacitor is connected to the output terminal of the fourth low dropout linear regulator circuit.

A heteronymous terminal of the third winding is respectively connected to a drain of the first transistor and one end of the fifth resistor.

A source of the first transistor is connected to the controller via a second buffer.

The other end of the fifth resistor is connected to the second input terminal of the detector.

Further, the secondary-side control circuit further includes a charging protocol circuit.

The controller is connected to the charging protocol circuit.

Further, the charging protocol circuit further includes a digital controller and a USB PD controller.

The sixth resistor and the seventh resistor in the output control circuit are replaced by a second transistor and a fifth capacitor.

A drain of the second transistor is respectively connected to the one end of the second electrolytic capacitor, the first input terminal of the voltage regulator, and the input terminal of the fourth low dropout linear regulator circuit.

A source of the second transistor is respectively connected to one end of the fifth capacitor and the USB PD controller.

A gate of the second transistor is connected to a first output terminal of the digital controller.

The other end of the fifth capacitor is connected to the other end of the eighth resistor.

An input terminal of the digital controller is connected to the first input terminal of the detector.

A second output terminal of the digital controller is connected to the positive terminal of the second comparator.

The USB PD controller is respectively connected to the first input terminal of the detector and the output terminal of the fourth low dropout linear regulator circuit.

Control lines of the digital controller and the USB PD controller are connected in sequence.

Furthermore, the logic control and fault protection circuit includes a fourth comparator, a first fault manager, a second AND gate, a second OR gate, a second oscillator, a first power manager, a fifth comparator, a sixth comparator, and a third transistor.

The output terminal of the AC overvoltage protection circuit is connected to a positive terminal of the fourth comparator.

A first output terminal of the first power manager is connected to a negative terminal of the fourth comparator.

An output terminal of the fourth comparator is connected to a first input terminal of the first fault manager.

The output terminal of the brown-in/brown-out protection circuit is connected to a second input terminal of the first fault manager.

The output terminal of the VCC overvoltage protection circuit is connected to a third input terminal of the first fault manager.

A fourth input terminal of the first fault manager is connected to an output terminal of an internal overtemperature protection circuit.

An output terminal of the first fault manager, after inversion, is connected to a first input terminal of the second AND gate.

The output terminal of the first low dropout linear regulator circuit is connected to a first input terminal of the first power manager.

A second input terminal of the first power manager is connected to an output terminal of a soft-start circuit.

A second output terminal of the first power manager is connected to the negative terminal of a fifth comparator.

A third output terminal of the first power manager is connected to a negative terminal of the sixth comparator.

A fourth output terminal of the first power manager is connected to the first input terminal of the third low dropout linear regulator circuit.

A fifth output terminal of the first power manager is connected to the negative terminal of the first comparator.

A positive terminal of the fifth comparator is connected to the signal output terminal of the millimeter wave receiver via the first buffer.

An output terminal of the fifth comparator is connected to a second input terminal of the second AND gate.

A positive terminal of the sixth comparator receives a DC voltage.

An output terminal of the sixth comparator is connected to the receiving enable terminal of the millimeter wave receiver.

An input terminal of the second oscillator is connected to the output terminal of the maximum frequency setting circuit.

An output terminal of the second oscillator is connected to a third input terminal of the second AND gate.

An output terminal of the second AND gate is connected to the S terminal of the RS flip-flop.

A first input terminal of the second OR gate is connected to a maximum on-time setting circuit.

A second input terminal of the second OR gate is connected to the output terminal of the first comparator.

An output terminal of the second OR gate is connected to the R terminal of the RS flip-flop.

The output terminal of the X capacitor discharge circuit is connected to a gate of the third transistor.

A drain of the third transistor is connected to an AC input.

A source of the third transistor is grounded.

Furthermore, the controller includes a seventh comparator, a second power manager, an SR drive signal manager, a second fault manager, an SR enable circuit, and a pulse frequency modulator.

The output terminal of the LATCH/auto recovery circuit is connected to an input terminal of the second power manager.

A second input terminal of the second power manager is connected to a negative terminal of the seventh comparator.

The other end of the sixth resistor is connected to a positive terminal of the seventh comparator.

An output terminal of the seventh comparator is connected to the transmitting enable terminal of the millimeter wave transmitter.

A second output terminal of the external overtemperature protection circuit, the output terminal of the Schmitt trigger, and the output terminal of the LATCH/auto recovery circuit are all connected to an input terminal of the second fault manager.

An output terminal of the second fault manager, an output terminal of the pulse frequency modulator, a second output terminal of the detector, and the third output terminal of the first oscillator are all connected to an input terminal of the SR drive signal manager.

A first output terminal of the SR drive signal manager is connected to an input terminal of the second buffer.

A second output terminal of the SR drive signal manager is connected to the first input terminal of the first OR gate.

A third output terminal of the SR drive signal manager is connected to an input terminal of the SR enable circuit.

An output terminal of the SR enable circuit is connected to the second input terminal of the first AND gate.

Furthermore, the synchronous rectification circuit is a synchronous rectification chip, and the charging protocol circuit is a charging protocol chip.

Furthermore, the synchronous rectification circuit and the charging protocol circuit are respectively integrated in the controller.

Furthermore, a plurality of the charging protocol circuits are integrated in the controller.

The present invention has the following beneficial effects: The primary-side control circuit and the secondary-side control circuit of the switching power supply are integrated on the same chip, and the controller is provided on the single chip. The controller controls the primary-side control circuit and the secondary-side control circuit. Moreover, the controller communicates with the primary-side control circuit via the millimeter wave transceiver. The isolation provided by the millimeter wave transceiver ensures the required safety distance between the primary-side control circuit and the secondary-side control circuit, and thereby, the single-chip design integrating the primary-side control circuit and the secondary-side control circuit is achieved. The single-chip design, which is simple in structure, not only ensures simplified design and smaller size of the switching power supply, but also reduces EMI interference. In addition, since control signals of both the primary-side control circuit and the secondary-side control circuit are generated by the controller, the control of the primary-side control circuit does not require feedback from the secondary-side control circuit, but is directly generated by the controller. The control

signals are transreceived by the controller via the millimeter wave transceiver, which greatly increases the transreceiving speed of the control signals, resulting in low latency and high efficiency.

### BRIEF DESCRIPTION OF THE DRAWINGS

FIG. 1 is a schematic circuit structure diagram of primary-side and secondary-side control circuits of a switching power supply in the prior art;

FIG. 2 is a schematic circuit structure diagram of a switching power supply according to an embodiment of the present invention;

FIG. 3 is a schematic internal structure diagram of a controller of the switching power supply according to an embodiment of the present invention;

FIG. 4 is a schematic circuit connection diagram of the controller of the switching power supply according to an embodiment of the present invention;

FIG. 5 is a schematic structure diagram of the switching power supply according to an embodiment of the present invention;

FIG. 6 is a schematic structure diagram of a primary-side control circuit in the switching power supply according to an embodiment of the present invention;

FIG. 7 is a schematic structure diagram of a millimeter wave transceiver in the switching power supply according to an embodiment of the present invention.

FIG. 8 is a schematic structure diagram of a secondary-side control circuit in the switching power supply according to an embodiment of the present invention;

FIG. 9 is a schematic structure diagram achieving integrated design in the switching power supply according to an embodiment of the present invention;

FIG. 10 is another schematic structure diagram of a switching power supply including a charging protocol circuit according to an embodiment of the present invention;

FIG. 11 is a schematic structure diagram of a secondary-side control circuit including a charging protocol in the switching power supply according to an embodiment of the present invention;

FIG. 12 is another schematic structure diagram of integrated design of the switching power supply including the charging protocol circuit according to an embodiment of the present invention;

FIG. 13 is a circuit structure diagram of a logic control and fault protection circuit in the switching power supply according to an embodiment of the present invention; and

FIG. 14 is a circuit structure diagram of the controller in the switching power supply according to an embodiment of the present invention.

### DESCRIPTION OF REFERENCE NUMERALS

1, millimeter wave transceiver; 11, millimeter wave transmitting circuit; 12, millimeter wave receiving circuit; 111, millimeter wave transmitter; 121, millimeter wave receiver; 112, transmitting antenna; 122, receiving antenna; 2, controller; 21, seventh comparator; 22, second power manager; 23, SR drive signal manager; 24, second fault manager; 25, SR enable circuit; 26, pulse frequency modulator; 3, primary-side control circuit; 31, driver; 32, power transistor; 33, logic control and fault protection circuit; 331, fourth comparator; 332, first fault manager; 333, second AND gate; 334, second OR gate; 335, second oscillator; 336, first power manager; 337, fifth comparator; 338, sixth comparator; 339, third transistor; 341, AC overvoltage protection circuit; 342, brown-in/brown-out protection circuit; 343, X capacitor discharge circuit; 351, first low dropout linear regulator circuit; 353, second low dropout linear regulator circuit; 354, third low dropout linear regulator circuit; 352, VCC overvoltage protection circuit; 36, first buffer; 37, RS flip-flop; 381, negative voltage sampling circuit; 382, leading edge blanking circuit; 383, CS jitter correction circuit; 384, maximum frequency setting circuit; 385, first comparator; 4, secondary-side control circuit; 411, detector; 412, regulator; 413, fourth low dropout linear regulator circuit; 414, external overtemperature protection circuit; 415, Schmitt trigger; 416, LATCH/auto recovery circuit; 417, second comparator; 418, third comparator; 419, NOR gate; 420, first AND gate; 421, first OR gate; 422, first oscillator; 423, digital controller; 424, USB PD controller; 5, transformer; 61, rectifier bridge; 621, first diode; 622, second diode; 631, first resistor; 641, first electrolytic capacitor; 632, second resistor; 651, first capacitor; 623, third diode; 624, fourth diode; 633, third resistor; 652, second capacitor; 634, fourth resistor; 711, first transistor; 72, second electrolytic capacitor; 731, fifth resistor; 741, third capacitor; 742, fourth capacitor; 732, sixth resistor; 733, seventh resistor; 734, eighth resistor.

### DETAILED DESCRIPTION OF THE DRAWINGS AND THE PRESENTLY PREFERRED EMBODIMENTS

To describe in detail the technical content, objectives achieved, and effects of the present invention, the following is explained in conjunction with the implementations and the accompanying drawings.

The switching power supply described in this application can be applied to various fields requiring charging, such as automation control, scientific research equipment, LED lighting, industrial control equipment and communication equipment. The following description is provided through specific implementations.

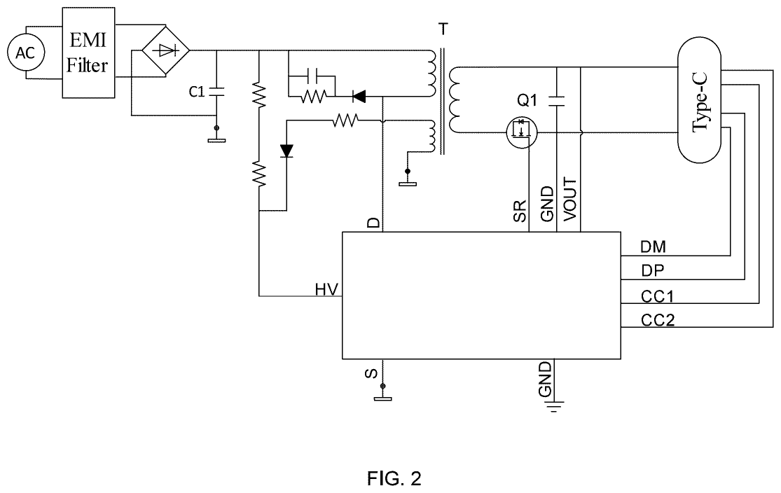

In one optional implementation, referring to FIG. 2, a switching power supply includes a primary-side control circuit 3 and a secondary-side control circuit 4, and further includes a controller 2 and a millimeter wave transceiver 1.

The primary-side control circuit 3, the secondary-side control circuit 4, the controller 2, and the millimeter wave transceiver 1 are integrated on a same chip.

The controller 2 is connected to the primary-side control circuit 3 via the millimeter wave transceiver 1.

The controller 2 is connected to the secondary-side control circuit 4.

To achieve millimeter wave transreceiving, in one optional implementation, the millimeter wave transceiver 1 includes a millimeter wave transmitting circuit 11 and a millimeter wave receiving circuit 12.

One end of the millimeter wave transmitting circuit 11 is connected to the controller 2, and the other end is wirelessly connected to one end of the millimeter wave receiving circuit 12.

The other end of the millimeter wave receiving circuit 12 is connected to the primary-side control circuit 3. The controller 2 transreceives a pulse width modulation (PWM) signal via the millimeter wave transmitting circuit 11 and the receiving circuit. The controller 2 directly outputs the PWM signal to the primary-side control circuit 3, without requiring feedback from the secondary-side control circuit 4.

In this implementation, signal transreceiving between the controller 2 and the primary-side control circuit 3 is achieved via the millimeter wave transceiver 1.

As the millimeter wave transceiver 1 utilizes millimeter waves for signal transreceiving, it provides spatial isolation between the primary-side control circuit 3 and the secondary-side control circuit 4. Moreover, control signals for the primary-side control circuit 3 are directly sent by the controller 2 via the millimeter wave transceiver 1, greatly improving the signal transreceiving speed.

In another optional implementation, the millimeter wave transceiver 1 is a millimeter wave transceiver chip. Chip-level design can further reduce the size of the switching power supply and enable thin and light device design.

In another optional implementation, the primary-side control circuit 3 is a switching power supply chip. In this implementation, chip-level design of the primary-side control circuit 3 further reduces the size of the switching power supply.

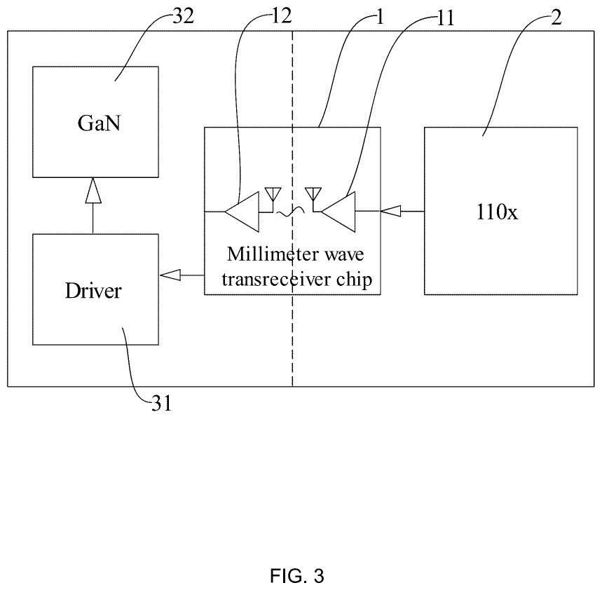

As shown in FIG. 3, in one optional implementation, the primary-side control circuit 3 includes a driver 31 (Driver) and a power transistor 32 (GaN).

The controller 2 is connected to an input terminal of the driver 31 via the millimeter wave transceiver 1.

An output terminal of the driver 31 is connected to the power transistor 32.

During specific implementation, the controller 2 transreceives the PWM signal to the driver 31 (Driver) via the millimeter wave transceiver 1. The driver 31 (Driver) controls the operation of the power transistor 32 (GaN) under the control of the PWM signal. The GaN provides outputs to drive the transformer 5T. HV is the primary-side high-voltage supply pin, D is the drain pin of the GaN, S is the source pin of the GaN, and S is connected to the primary-side ground.

In this implementation, the controller 2 is a 110x series controller 2.

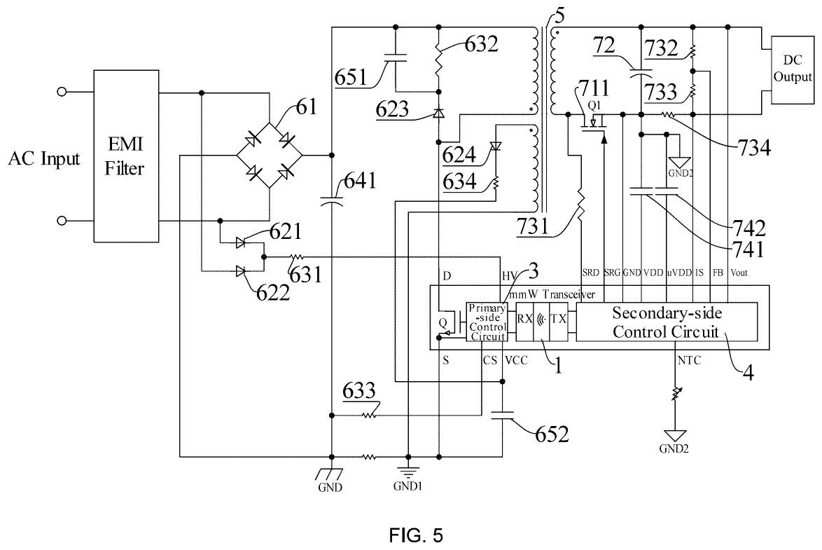

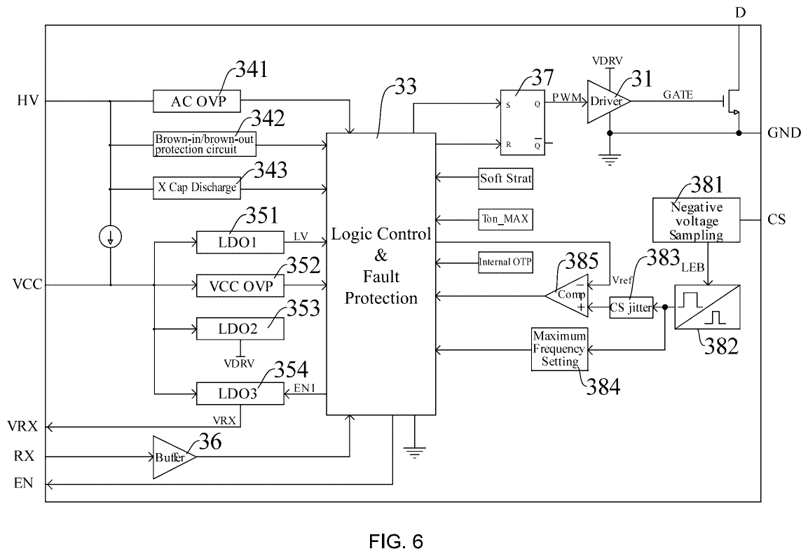

In another optional implementation, as shown in FIG. 5 and FIG. 6, the primary-side control circuit 3 includes a logic control and fault protection circuit 33 (Logic Control &Fault Protection), an overvoltage protection circuit, and a regulator circuit.

The overvoltage protection circuit and the regulator circuit are respectively connected to the logic control and fault protection circuit 33.

The logic control and fault protection circuit 33 is connected to the millimeter wave transceiver 1 (mmW Transceiver) via the regulator circuit.

In FIG. 6, Soft-Start denotes soft start; Ton_MAX denotes maximum on-time; and Internal OTP denotes internal overtemperature protection.

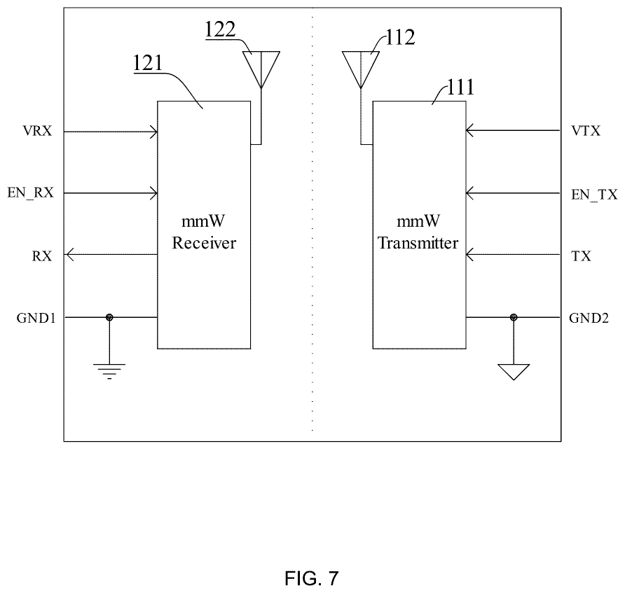

In another optional implementation, as shown in FIG. 7, the millimeter wave transceiver 1 includes a millimeter wave transmitter 111 (mmW Transmitter), a millimeter wave receiver 121 (mmW Receiver), a transmitting antenna 112, and a receiving antenna 122.

The logic control and fault protection circuit 33 is connected to one end of the millimeter wave receiver 121 via the regulator circuit, and the other end of the millimeter wave receiver 121 is connected to the receiving antenna 122.

One end of the millimeter wave transmitter 111 is connected to the controller 2 in the secondary-side control circuit 4, and the other end is connected to the transmitting antenna 112.

The transmitting antenna 112 communicates with the receiving antenna 122 via millimeter waves.

In another optional implementation, as shown in FIG. 6, the overvoltage protection circuit includes an AC overvoltage protection circuit 341 (AC OVP), a brown-in/brown-out protection circuit 342 (Brown In/Brown Out), and an X capacitor discharge circuit 343 (X Cap Discharge).

The regulator circuit includes a first low dropout linear regulator circuit 351 (LDO1), a second low dropout linear regulator circuit 353 (LDO2), a third low dropout linear regulator circuit 354 (LDO3), and a VCC overvoltage protection circuit 352 (VCC OVP).

As shown in FIG. 7, the millimeter wave receiver 121 includes a signal output terminal RX, a receiving power supply terminal VRX, and a receiving enable terminal EN_RX.

An output terminal of the AC overvoltage protection circuit 341, an output terminal of the brown-in/brown-out protection circuit 342, an output terminal of the X capacitor discharge circuit 343, an output terminal of the first low dropout linear regulator circuit 351, and an output terminal of the VCC overvoltage protection circuit 352 are all connected to an input terminal of the logic control and fault protection circuit 33.

An output terminal of the second low dropout linear regulator circuit 353 is connected to a power input terminal of the power transistor 32.

A first enable terminal EN1 of the logic control and fault protection circuit 33 is connected to a first input terminal of the third low dropout linear regulator circuit 354.

An output terminal of the third low dropout linear regulator circuit 354 is connected to the receiving power supply terminal of the millimeter wave receiver 121.

The signal output terminal of the millimeter wave receiver 121 is connected to the logic control and fault protection circuit 33 via a first buffer 36.

A second enable terminal of the logic control and fault protection circuit 33 is connected to the receiving enable terminal of the millimeter wave receiver 121.

In another optional implementation, the switching power supply further includes an input control circuit.

The input control circuit is respectively connected to a drain D of the power transistor 32, an input terminal of the AC overvoltage protection circuit 341, an input terminal of the brown-in/brown-out protection circuit 342, an input terminal of the X capacitor discharge circuit 343, an input terminal of the first low dropout linear regulator circuit 351, an input terminal of the VCC overvoltage protection circuit 352, an input terminal of the second low dropout linear regulator circuit 353, a second input terminal of the third low dropout linear regulator circuit 354, and the input terminal of the logic control and fault protection circuit 33.

In another optional implementation, the primary-side control circuit 3 further includes an RS flip-flop 37 and a driver 31 (Driver).

An S terminal and an R terminal of the RS flip-flop 37 are both connected to the logic control and fault protection circuit 33, a Q terminal is connected to the input terminal of the driver 31, and the output terminal of the driver 31 is connected to a gate of the power transistor 32.

In another optional implementation, the switching power supply further includes a negative voltage sampling circuit 381 (Negative voltage Sampling), a leading edge blanking circuit 382 (LEB), a CS jitter correction circuit 383 (CS jitter), a maximum frequency setting circuit 384 (Maximum Frequency Setting), and a first comparator 385 (Comp).

The input control circuit is connected to an input terminal of the negative voltage sampling circuit 381.

An output terminal of the negative voltage sampling circuit 381 is connected to an input terminal of the leading edge blanking circuit 382.

An output terminal of the leading edge blanking circuit 382 is respectively connected to an input terminal of the CS jitter correction circuit 383 and an input terminal of the maximum frequency setting circuit 384.

An output terminal of the CS jitter correction circuit 383 is connected to a positive terminal of the first comparator 385.

A negative terminal of the first comparator 385 is connected to a first reference voltage.

An output terminal of the first comparator 385 and an output terminal of the maximum frequency setting circuit 384 are respectively connected to the logic control and fault protection circuit 33.

In another optional implementation, as shown in FIG. 5, the switching power supply further includes a transformer 5.

The input control circuit includes a rectifier bridge 61, a first diode 621, a second diode 622, a first resistor 631, a first electrolytic capacitor 641, a second resistor 632, a first capacitor 651, a third diode 623, a fourth diode 624, a third resistor 633, a second capacitor 652, and a fourth resistor 634.

One end of an AC input terminal of the rectifier bridge 61 is connected to an anode of the first diode 621, and the other end is connected to an anode of the second diode 622. Optionally, the AC input terminal is connected with an EMI filter.

A cathode of the first diode 621 and a cathode of the second diode 622 are both connected to one end of the first resistor 631, and the other end of the first resistor 631 is respectively connected to the input terminal of the AC overvoltage protection circuit 341, the input terminal of the brown-in/brown-out protection circuit 342, the input terminal of the X capacitor discharge circuit 343, the input terminal of the first low dropout linear regulator circuit 351, the input terminal of the VCC overvoltage protection circuit 352, the input terminal of the second low dropout linear regulator circuit 353, and the second input terminal of the third low dropout linear regulator circuit 354.

A primary side of the transformer 5 includes a first winding and a second winding.

One end of a DC terminal of the rectifier bridge 61 is grounded, and the other end is respectively connected to a heteronymous terminal of the first winding, one end of the second resistor 632, one end of the first capacitor 651, and one end of the first electrolytic capacitor 641.

The other end of the first electrolytic capacitor 641 is connected to one end of the third resistor 633.

The other end of the third resistor 633 is connected to the input terminal of the negative voltage sampling circuit 381.

The other end of the second resistor 632 and the other end of the first capacitor 651 are respectively connected to a cathode of the third diode 623.

An anode of the third diode 623 is respectively connected to the drain of the power transistor 32 and a homonymous terminal of the first winding.

A homonymous terminal of the second winding is connected to an anode of the fourth diode 624.

A cathode of the fourth diode 624 is connected to one end of the fourth resistor 634.

The other end of the fourth resistor 634 is respectively connected to the input terminal of the first low dropout linear regulator circuit 351, the input terminal of the VCC overvoltage protection circuit 352, the input terminal of the second low dropout linear regulator circuit 353, the second input terminal of the third low dropout linear regulator circuit 354, and one end of the second capacitor 652.

The other end of the second capacitor 652, a heteronymous terminal of the second winding, and a source of the power transistor 32 are all grounded.

In another optional implementation, the switching power supply further includes an output control circuit.

The output control circuit is respectively connected to a secondary side of the transformer 5 and the secondary-side control circuit 4.

In another optional implementation, as shown in FIG. 7, the millimeter wave transmitter 111 includes a transmitting power supply terminal VTX, a signal input terminal TX, and a transmitting enable terminal EN_TX.

The secondary-side control circuit 4 includes a synchronous rectification circuit, and the controller 2 is connected to the synchronous rectification circuit.

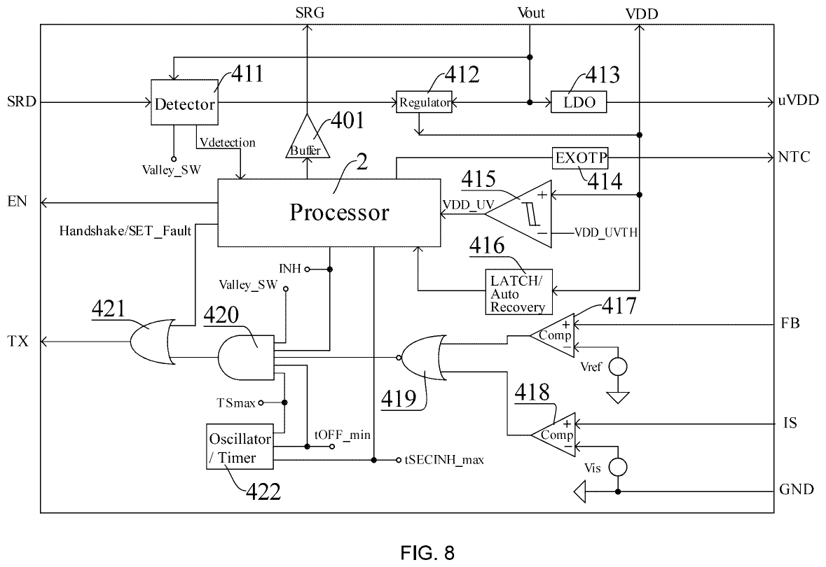

As shown in FIG. 8, the synchronous rectification circuit includes controller 2 (Processor), a detector 411 (Detector), a regulator 412 (Regulator), a fourth low dropout linear regulator circuit 413 (LDO), an external overtemperature protection circuit 414 (EXOTP), a Schmitt trigger 415, a LATCH/auto recovery circuit 416 (LATCH/Auto Recovery), a second comparator 417, a third comparator 418, a NOR gate 419, a first AND gate 420, a first OR gate 421, and a first oscillator 422 (Oscillator/Timer).

A first input terminal and a second input terminal of the detector 411, a first input terminal and an output terminal of the regulator 412, an input terminal and an output terminal of the fourth low dropout linear regulator circuit 413, an output terminal of the external overtemperature protection circuit 414, a positive terminal of the Schmitt trigger 415, an input terminal of the LATCH/auto recovery circuit 416, a positive terminal of the second comparator 417, and a positive terminal of the third comparator 418 are respectively connected to the output control circuit.

A first output terminal of the detector 411 is connected to a second input terminal of the regulator 412, and the second output terminal is connected to the controller 2.

An input terminal of the external overtemperature protection circuit 414 is connected to the controller 2.

An output terminal of the Schmitt trigger 415 and an output terminal of the LATCH/auto recovery circuit 416 are both connected to the controller 2.

An output terminal of the second comparator 417 is connected to a first input terminal of the NOR gate 419.

An output terminal of the third comparator 418 is connected to a second input terminal of the NOR gate 419.

An output terminal of the NOR gate 419 is connected to a third input terminal of the first AND gate 420.

A first input terminal of the first AND gate 420 is connected to a third output terminal of the detector 411.

A second input terminal of the first AND gate 420 is connected to the controller 2.

A first output terminal and a second output terminal of the first oscillator 422 are connected to a fourth input terminal and a fifth input terminal of the first AND gate 420.

A third output terminal of the first oscillator 422 is connected to the controller 2.

A first input terminal of the first OR gate 421 is connected to the controller 2.

An output terminal of the first AND gate 420 is connected to a second input terminal of the first OR gate 421.

An output terminal of the first OR gate 421 is connected to the signal input terminal of the millimeter wave transmitter 111.

An enable terminal of the controller 2 is connected to the transmitting enable terminal of the millimeter wave transmitter 111.

The output terminal of the fourth low dropout linear regulator circuit 413 is connected to the receiving terminal of the millimeter wave transmitter 111.

The first output terminal TSmax of the first oscillator 422 represents the maximum switching cycle, the second output terminal tOFF_min represents the minimum off-time, and the third output terminal tSECINH_max represents the maximum secondary INH time.

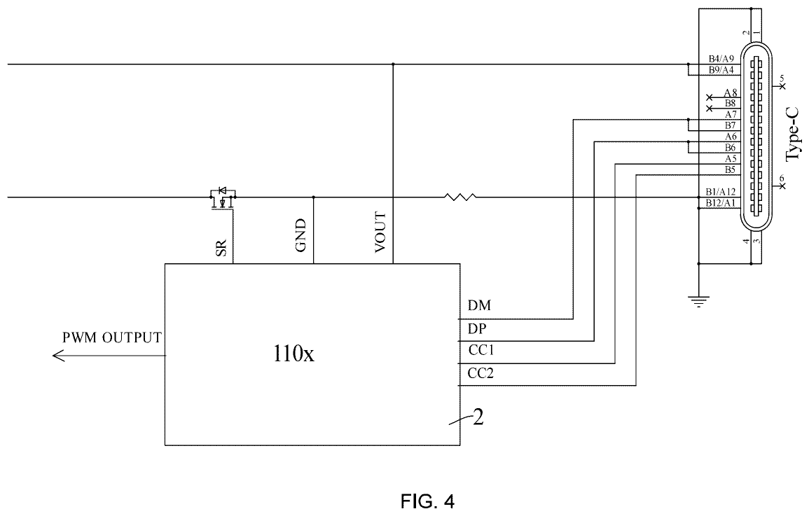

In FIG. 4, Handshake/SET_Fault represents primary/secondary handshake/fault setting; INH represents input high; and VDD_UVTH represents VDD undervoltage threshold. VDD_UV represents undervoltage signal; and Vis represents current source.

Specifically, as shown in FIG. 5 and FIG. 8, the output control circuit includes a first transistor 711 Q1, a second electrolytic capacitor 72, a fifth resistor 731, a third capacitor 741, a fourth capacitor 742, a sixth resistor 732, a seventh resistor 733, and an eighth resistor 734.

The secondary side of the transformer 5 includes a third winding.

A homonymous terminal of the third winding is respectively connected to one end of the second electrolytic capacitor 72, one end of the sixth resistor 732, the first input terminal of detector 411, and the input terminal of the fourth low dropout linear regulator circuit 413.

The other end of the second electrolytic capacitor 72 is respectively connected to a source of the first transistor 711, one end of the third capacitor 741, one end of the fourth capacitor 742, and one end of the eighth resistor 734, all of which are grounded.

The other end of the sixth resistor 732 is respectively connected to one end of the seventh resistor 733 and the positive terminal of the second comparator 417.

The other end of the seventh resistor 733 is respectively connected to the other end of the eighth resistor 734 and the positive terminal of the second comparator 417.

The other end of the third capacitor 741 is respectively connected to the output terminal of the regulator 412 and the positive terminal of the Schmitt trigger 415.

The other end of the fourth capacitor 742 is connected to the output terminal of the fourth low dropout linear regulator circuit 413.

A heteronymous terminal of the third winding is respectively connected to a drain of the first transistor 711 and one end of the fifth resistor 731.

A source of the first transistor 711 is connected to the controller 2 via a second buffer 401.

The other end of the fifth resistor 731 is connected to the second input terminal of the detector 411.

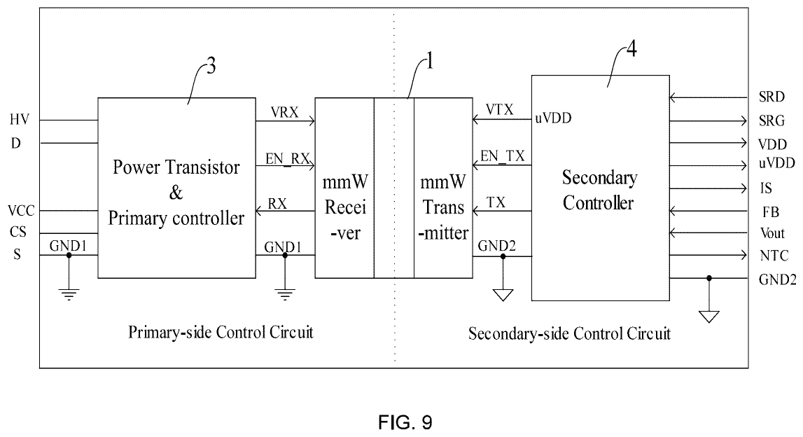

FIG. 9 shows a schematic diagram of the primary-side control circuit 3, the secondary-side control circuit 4, and the millimeter wave transceiver 1 integrated on the same chip, which provides fixed pins externally. Connections can be made according to the corresponding pins.

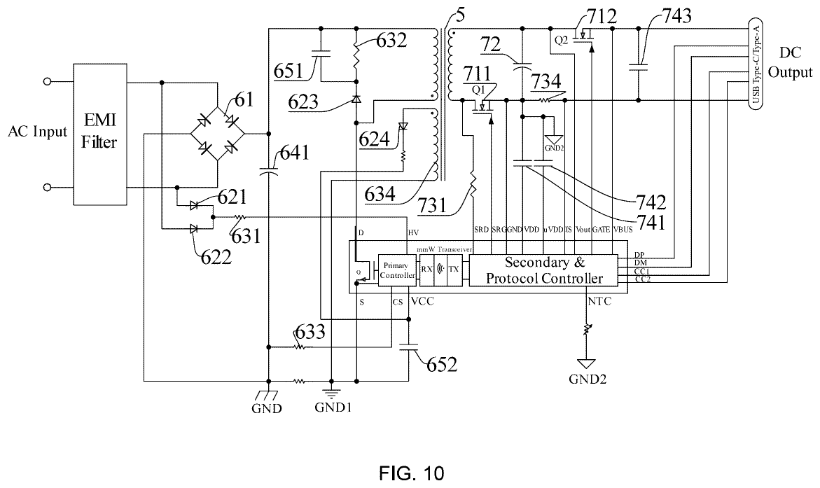

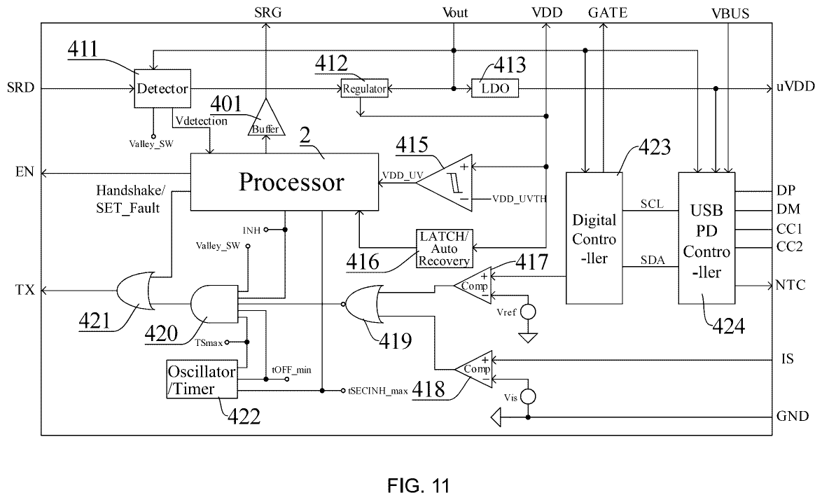

In another optional implementation, as shown in FIG. 10 and FIG. 11, the secondary-side control circuit 4 further includes a charging protocol circuit. The controller 2 is connected to the charging protocol circuit. That is, the secondary-side control circuit 4 includes a synchronous rectification circuit and a charging protocol circuit.

The controller 2 is respectively connected to the synchronous rectification circuit and the charging protocol circuit.

In this implementation, unified control of the synchronous rectification circuit and the charging protocol circuit in the secondary-side control circuit 4 is achieved via the controller 2.

Specifically, the charging protocol circuit includes a digital controller 423 and a USB PD controller 424.

The sixth resistor 732 and the seventh resistor 733 in the output control circuit, are replaced by a second transistor 712 Q2 and a fifth capacitor 743.

A drain of the second transistor 712 is respectively connected to one end of the second electrolytic capacitor 72, the first input terminal of the regulator 412, and the input terminal of the fourth low dropout linear regulator circuit 413.

A source of the second transistor 712 is respectively connected to one end of the fifth capacitor 743 and the USB PD controller 424.

A gate of the second transistor 712 is connected to the first output terminal of the digital controller 423.

The other end of the fifth capacitor 743 is connected to the other end of the eighth resistor 734.

An input terminal of the digital controller 423 is connected to the first input terminal of the detector 411.

A second output terminal of the digital controller 423 is connected to the positive terminal of the second comparator 417.

The USB PD controller 424 is respectively connected to the first input terminal of the detector 411 and the output terminal of the fourth low dropout linear regulator circuit 413.

Control lines of the digital controller 423 and the USB PD controller 424 are connected in sequence.

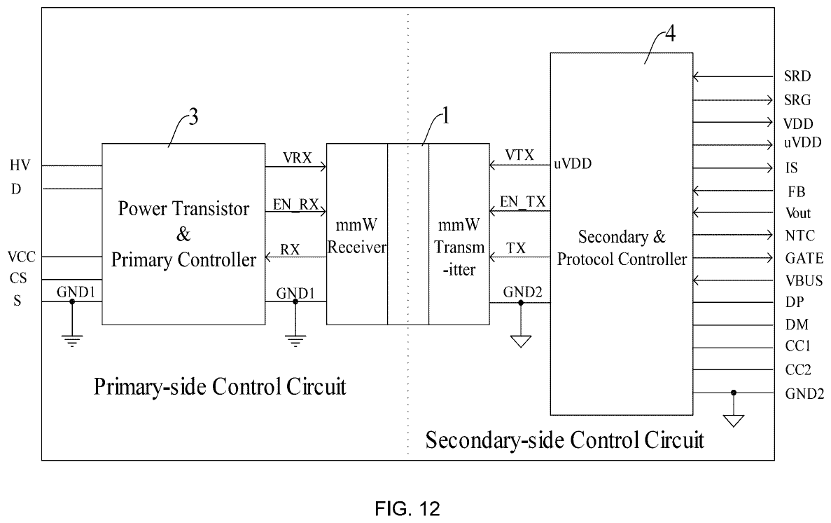

FIG. 12 shows a schematic diagram of the primary-side control circuit 3, the secondary-side control circuit 4 including the charging protocol, and the millimeter wave transceiver circuit integrated on the same chip, which provides fixed pins externally. Connections can be made according to the corresponding pins, where DM/DP are USB Type-C/Type-A signal pins, and CC1/CC2 pins are USB Type-C/Type-A detection pins. In actual use, the corresponding pins are connected to the corresponding circuits of the switching power supply as shown in FIG. 10.

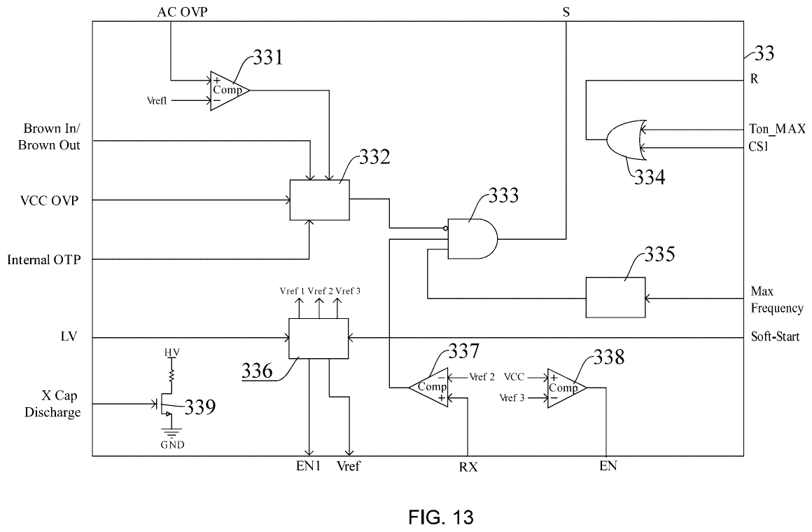

In another optional implementation, as shown in FIG. 13, the logic control and fault protection circuit 33 includes a fourth comparator 331, a first fault manager 332, a second AND gate 333, a second OR gate 334, a second oscillator 335, a first power manager 336, a fifth comparator 337, a sixth comparator 338, and a third transistor 339.

The output terminal of the AC overvoltage protection circuit 341 is connected to a positive terminal of the fourth comparator 331.

A first output terminal of the first power manager 336 is connected to a negative terminal of the fourth comparator 331.

An output terminal of the fourth comparator 331 is connected to a first input terminal of the first fault manager 332.

The output terminal of the brown-in/brown-out protection circuit 342 is connected to a second input terminal of the first fault manager 332.

The output terminal of the VCC overvoltage protection circuit 352 is connected to a third input terminal of the first fault manager 332.

A fourth input terminal of the first fault manager 332 is connected to an output terminal of an internal overtemperature protection circuit.

An output terminal of the first fault manager 332, after inversion, is connected to a first input terminal of the second AND gate 333.

The output terminal of the first low dropout linear regulator circuit 351 is connected to a first input terminal of the first power manager 336.

A second input terminal of the first power manager 336 is connected to an output terminal of a soft-start circuit.

A second output terminal of the first power manager 336 is connected to the negative terminal of the fifth comparator 337.

A third output terminal of the first power manager 336 is connected to a negative terminal of the sixth comparator 338.

A fourth output terminal of the first power manager 336 is connected to the first input terminal of the third low dropout linear regulator circuit 354.

A fifth output terminal of the first power manager 336 is connected to the negative terminal of the first comparator 385.

A positive terminal of the fifth comparator 337 is connected to the signal output terminal of the millimeter wave receiver 121 via the first buffer 36.

An output terminal of the fifth comparator 337 is connected to a second input terminal of the second AND gate 333.

A positive terminal of the sixth comparator 338 receives a DC voltage (VCC).

An output terminal of the sixth comparator 338 is connected to the receiving enable terminal of the millimeter wave receiver 121.

An input terminal of the second oscillator 335 is connected to the output terminal of the maximum frequency setting circuit 384.

An output terminal of the second oscillator 335 is connected to a third input terminal of the second AND gate 333.

An output terminal of the second AND gate 333 is connected to the S terminal of the RS flip-flop 37.

A first input terminal of the second OR gate 334 is connected to a maximum on-time setting circuit.

A second input terminal of the second OR gate 334 is connected to the output terminal of the first comparator 385.

An output terminal of the second OR gate 34 is connected to the R terminal of the RS flip-flop 37.

The output terminal of the X capacitor discharge circuit 343 is connected to a gate of the third transistor 339.

A drain of the third transistor 339 is connected to an AC input (HV).

A source of the third transistor 339 is grounded.

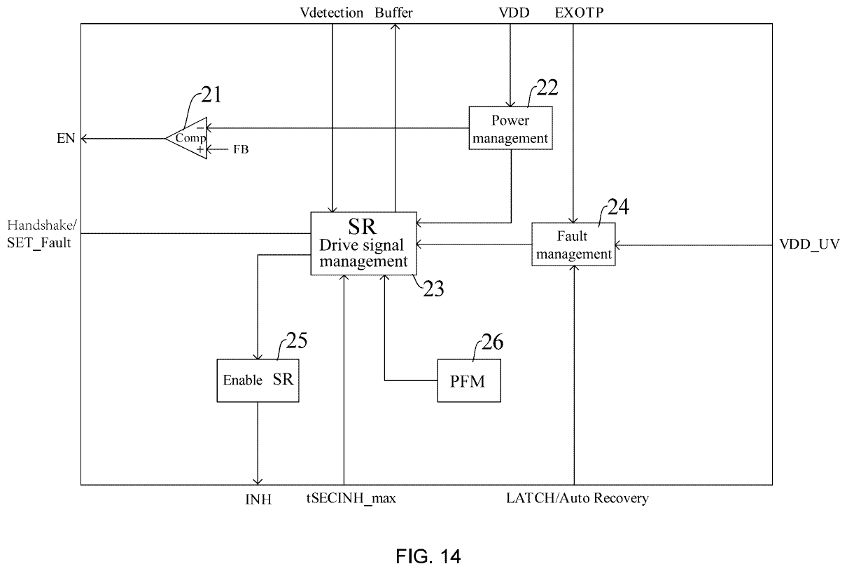

In another optional implementation, as shown in FIG. 14, the controller 2 includes a seventh comparator 21, a second power manager 22, an SR drive signal manager 23, a second fault manager 24, an SR enable circuit 25, and a pulse frequency modulator 26.

The output terminal of the LATCH/auto recovery circuit 416 is connected to an input terminal of the second power manager 22.

A second input terminal of the second power manager 22 is connected to a negative terminal of the seventh comparator 21.

The other end of the sixth resistor 732 is connected to a positive terminal of the seventh comparator 21.

An output terminal of the seventh comparator 21 is connected to the transmitting enable terminal of the millimeter wave transmitter 111.

A second output terminal of the external overtemperature protection circuit 414, the output terminal of the Schmitt trigger 415, and the output terminal of the LATCH/auto recovery circuit 416 are all connected to an input terminal of the second fault manager 24.

An output terminal of the second fault manager 24, an output terminal of the pulse frequency modulator 26, a second output terminal of the detector 411, and the third output terminal of the first oscillator 422 are all connected to an input terminal of the SR drive signal manager 23.

A first output terminal of the SR drive signal manager 23 is connected to an input terminal of the second buffer 401.

A second output terminal of the SR drive signal manager 23 is connected to the first input terminal of the first OR gate 421.

A third output terminal of the SR drive signal manager 23 is connected to an input terminal of the SR enable circuit 25.

An output terminal of the SR enable circuit 25 is connected to the second input terminal of the first AND gate 420.

In another optional implementation, to further achieve thin and light design, the synchronous rectification circuit is a synchronous rectification chip, and the charging protocol circuit is a charging protocol chip.

In another optional implementation, the synchronous rectification circuit and the charging protocol circuit are respectively integrated in the controller 2, that is, the synchronous rectification circuit and the charging protocol circuit are embedded inside the controller 2, enabling synchronous rectification and charging functions. Through this integrated design, the size of the switching power supply is further reduced.

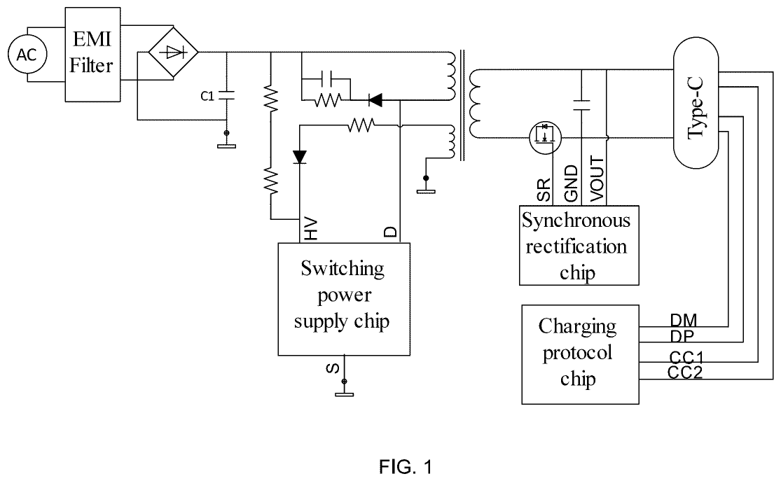

In specific implementation, as shown in FIG. 2 and FIG. 4, the 110x controller 2 externally provides a PWM OUTPUT pin, an SR pin, a GND pin, a VOUT pin, a DM pin, a DP pin, a CC1 pin, and a CC2 pin. After the 110x controller 2 is connected with the primary-side control circuit 3, which includes the driver 31 (Driver) and the power transistor 32 (GaN), via millimeter wave transceiver 1, the entire single chip as a whole externally provides an HV pin, a D pin, an S pin, an SR pin, a GND pin, a VOUT pin, a DM pin, a DP pin, a CC1 pin, and a CC2 pin. The HV pin is the primary-side high-voltage supply pin, the D pin is the GaN drain pin, the S pin is the GaN source pin, the SR pin is the secondary-side synchronous rectification output, the DM/DP are the USB Type-C signal pins, and the CC1/CC2 pins are the USB Type-C detection pins. In specific use, the corresponding pins are connected to the corresponding circuits of the switching power supply as shown in FIG. 1.

In another optional implementation, as shown in FIG. 3, the entire millimeter wave transreceiver control chip may adopt a PIP multi-chip packaging structure. The millimeter wave transreceiver control chip includes a 110x series controller, 2 millimeter wave transreceiver isolators, a driver 31 (Driver), and a GaN high-power transistor 32. The operation of each module within the millimeter wave transreceiver control single chip is uniformly controlled by the 110x series controller. The 110x series controller contains PWM control, synchronous rectification control, and PD charging protocol, and can incorporate relevant charging protocols from different manufacturers to support more fast charging. That is, the 110x series controller can integrate a plurality of charging protocol circuits, thereby improving the flexibility of the switching power supply in charging.

When the above-mentioned millimeter wave transreceiver control chip is applied to an actual switching power supply, as shown in FIG. 2, the switching power supply includes an input EMI filter circuit, a rectifier bridge 61 circuit, a coupled transformer 5T, a synchronous rectifier tube Q1, a millimeter wave transreceiver control chip, and an output USB Type-C interface. The millimeter wave transreceiver control chip externally provides necessary pins for each circuit signal in the switching power supply circuit, as long as the millimeter wave transreceiver control chip is connected into the existing switching power supply circuit according to the connection relationships of the existing circuit signals.

Based on the above, according to the switching power supply provided by the present invention, the primary-side control circuit 3 and the secondary-side control circuit 4 of the switching power supply are integrated on the same chip, and the controller 2 is provided on the single chip. The controller 2 controls the primary-side control circuit 3 and the secondary-side control circuit 4. Moreover, the controller 2 communicates with the primary-side control circuit 3 via the millimeter wave transceiver 1. The isolation provided by the millimeter wave transceiver 1 ensures the required safety distance between the primary-side control circuit 3 and the secondary-side control circuit 4, and thereby, the single-chip design integrating the primary-side control circuit 3 and the secondary-side control circuit 4 is achieved. Furthermore, the primary-side control circuit 3, the secondary-side control circuit 4, and the millimeter wave transceiver 1 all achieve chip-level design. The single chip design and the chip-level design not only ensure simplified design and smaller size of the switching power supply, but also reduce EMI interference. In addition, since control signals of both the primary-side control circuit 3 and the secondary-side control circuit 4 are generated by the controller 2, the control of the primary-side control circuit 3 does not require feedback from the secondary-side control circuit 4, but is directly generated by the controller 2. The control signals are transreceived by the controller 2 via the millimeter wave transceiver 1, which greatly increases the transreceiving speed of the control signals, resulting in low latency and high efficiency. The extremely simplified peripheral components further reduce the difficulty of design and debugging, reduce layout area, save costs, and enable ultra-high power density for the whole device. Compared to existing switching power supply solutions, the size can be reduced by 30% to 40%.

The above descriptions are merely embodiments of the present invention and do not limit the scope of the patent. Any equivalent modifications made based on the specification and accompanying drawings, or direct or indirect applications in related technical fields, are likewise included within the scope of patent protection of the present invention.

1. A switching power supply, comprising a primary-side control circuit and a secondary-side control circuit, and further comprising a controller and a millimeter wave transceiver; wherein
the primary-side control circuit, the secondary-side control circuit, the controller, and the millimeter wave transceiver are integrated on a same chip;
the controller is connected to the primary-side control circuit via the millimeter wave transceiver; and
the controller is connected to the secondary-side control circuit.

2. The switching power supply according to claim 1, wherein the millimeter wave transceiver comprises a millimeter wave transmitting circuit and a millimeter wave receiving circuit;
one end of the millimeter wave transmitting circuit is connected to the controller, and the other end is wirelessly connected to one end of the millimeter wave receiving circuit; and
the other end of the millimeter wave receiving circuit is connected to the primary-side control circuit.

3. The switching power supply according to claim 1, wherein the millimeter wave transceiver is a millimeter wave transceiver chip.

4. The switching power supply according to claim 1, wherein the primary-side control circuit is a switching power supply chip.

5. The switching power supply according to claim 1, wherein the primary-side control circuit comprises a driver and a power transistor;
the controller is connected to an input terminal of the driver via the millimeter wave transceiver; and
an output terminal of the driver is connected to the power transistor.

6. The switching power supply according to claim 5, wherein the primary-side control circuit comprises a logic control and fault protection circuit, an overvoltage protection circuit, and a regulator circuit;
the overvoltage protection circuit and the regulator circuit are respectively connected to the logic control and fault protection circuit; and
the logic control and fault protection circuit is connected to the millimeter wave transceiver via the regulator circuit.

7. The switching power supply according to claim 6, wherein the millimeter wave transceiver comprises a millimeter wave transmitter, a millimeter wave receiver, a transmitting antenna, and a receiving antenna;
the logic control and fault protection circuit is connected to one end of the millimeter wave receiver via the regulator circuit, and the other end of the millimeter wave receiver is connected to the receiving antenna;
one end of the millimeter wave transmitter is connected to the controller, and the other end is connected to the transmitting antenna; and
the transmitting antenna communicates with the receiving antenna via millimeter waves.

8. The switching power supply according to claim 7, wherein the overvoltage protection circuit comprises an AC overvoltage protection circuit, a brown-in/brown-out protection circuit, and an X capacitor discharge circuit;
the regulator circuit comprises a first low dropout linear regulator circuit, a second low dropout linear regulator circuit, a third low dropout linear regulator circuit, and a VCC overvoltage protection circuit;
the millimeter wave receiver comprises a signal output terminal, a receiving power supply terminal, and a receiving enable terminal;
an output terminal of the AC overvoltage protection circuit, an output terminal of the brown-in/brown-out protection circuit, an output terminal of the X capacitor discharge circuit, an output terminal of the first low dropout linear regulator circuit, and an output terminal of the VCC overvoltage protection circuit are all connected to an input terminal of the logic control and fault protection circuit;
an output terminal of the second low dropout linear regulator circuit is connected to a power input terminal of the power transistor;
a first enable terminal of the logic control and fault protection circuit is connected to a first input terminal of the third low dropout linear regulator circuit;
an output terminal of the third low dropout linear regulator circuit is connected to the receiving power supply terminal of the millimeter wave receiver;
the signal output terminal of the millimeter wave receiver is connected to the logic control and fault protection circuit via a first buffer; and
a second enable terminal of the logic control and fault protection circuit is connected to the receiving enable terminal of the millimeter wave receiver.

9. The switching power supply according to claim 8, further comprising an input control circuit; wherein
the input control circuit is respectively connected to a drain of the power transistor, an input terminal of the AC overvoltage protection circuit, an input terminal of the brown-in/brown-out protection circuit, an input terminal of the X capacitor discharge circuit, an input terminal of the first low dropout linear regulator circuit, an input terminal of the VCC overvoltage protection circuit, an input terminal of the second low dropout linear regulator circuit, a second input terminal of the third low dropout linear regulator circuit, and the input terminal of the logic control and fault protection circuit.

10. The switching power supply according to claim 9, wherein the primary-side control circuit further comprises an RS flip-flop; and
an S terminal and an R terminal of the RS flip-flop are both connected to the logic control and fault protection circuit, a Q terminal is connected to the input terminal of the driver, and the output terminal of the driver is connected to a gate of the power transistor.

11. The switching power supply according to claim 9, wherein the primary-side control circuit further comprises a negative voltage sampling circuit, a leading edge blanking circuit, a CS jitter correction circuit, a maximum frequency setting circuit, and a first comparator;
the input control circuit is connected to an input terminal of the negative voltage sampling circuit;
an output terminal of the negative voltage sampling circuit is connected to an input terminal of the leading edge blanking circuit;
an output terminal of the leading edge blanking circuit is respectively connected to an input terminal of the CS jitter correction circuit and an input terminal of the maximum frequency setting circuit;
an output terminal of the CS jitter correction circuit is connected to a positive terminal of the first comparator;
a negative terminal of the first comparator is connected to a first reference voltage; and
an output terminal of the first comparator and an output terminal of the maximum frequency setting circuit are respectively connected to the logic control and fault protection circuit.

12. The switching power supply according to claim 11, further comprising a transformer; wherein
the input control circuit comprises a rectifier bridge, a first diode, a second diode, a first resistor, a first electrolytic capacitor, a second resistor, a first capacitor, a third diode, a fourth diode, a third resistor, a second capacitor, and a fourth resistor;
one end of an AC input terminal of the rectifier bridge is connected to an anode of the first diode, and the other end is connected to an anode of the second diode;
a cathode of the first diode and a cathode of the second diode are both connected to one end of the first resistor, and the other end of the first resistor is respectively connected to the input terminal of the AC overvoltage protection circuit, the input terminal of the brown-in/brown-out protection circuit, and the input terminal of the X capacitor discharge circuit;
a primary side of the transformer comprises a first winding and a second winding;
one end of a DC terminal of the rectifier bridge is grounded, and the other end is respectively connected to a heteronymous terminal of the first winding, one end of the second resistor, one end of the first capacitor, and one end of the first electrolytic capacitor;
the other end of the first electrolytic capacitor is connected to one end of the third resistor;
the other end of the third resistor is connected to the input terminal of the negative voltage sampling circuit;
the other end of the second resistor and the other end of the first capacitor are respectively connected to a cathode of the third diode;
an anode of the third diode is respectively connected to the drain of the power transistor and a homonymous terminal of the first winding;
a homonymous terminal of the second winding is connected to an anode of the fourth diode;
a cathode of the fourth diode is connected to one end of the fourth resistor;
the other end of the fourth resistor is respectively connected to the input terminal of the first low dropout linear regulator circuit, the input terminal of the VCC overvoltage protection circuit, the input terminal of the second low dropout linear regulator circuit, the second input terminal of the third low dropout linear regulator circuit, and one end of the second capacitor; and
the other end of the second capacitor, a heteronymous terminal of the second winding, and a source of the power transistor are all grounded.

13. The switching power supply according to claim 12, further comprising an output control circuit; wherein
the output control circuit is respectively connected to a secondary side of the transformer and the secondary-side control circuit.

14. The switching power supply according to claim 13, wherein the secondary-side control circuit comprises a synchronous rectification circuit; and
the controller is connected to the synchronous rectification circuit.

15. The switching power supply according to claim 14, wherein the millimeter wave transmitter comprises a signal input terminal, a transmitting power supply terminal, and a transmitting enable terminal;
the synchronous rectification circuit comprises a detector, a regulator, a fourth low dropout linear regulator circuit, an external overtemperature protection circuit, a Schmitt trigger, a LATCH/auto recovery circuit, a second comparator, a third comparator, a NOR gate, a first AND gate, a first OR gate, and a first oscillator;
a first input terminal and a second input terminal of the detector, a first input terminal and an output terminal of the regulator, an input terminal and an output terminal of the fourth low dropout linear regulator circuit, a first output terminal of the external overtemperature protection circuit, a positive terminal of the Schmitt trigger, an input terminal of the LATCH/auto recovery circuit, a positive terminal of the second comparator, and a positive terminal of the third comparator are all connected to the output control circuit;
a first output terminal of the detector is connected to a second input terminal of the regulator, and the second output terminal is connected to the controller;
an input terminal of the external overtemperature protection circuit is connected to the controller;
an output terminal of the Schmitt trigger and an output terminal of the LATCH/auto recovery circuit are both connected to the controller;
an output terminal of the second comparator is connected to a first input terminal of the NOR gate;
an output terminal of the third comparator is connected to a second input terminal of the NOR gate;
an output terminal of the NOR gate is connected to a third input terminal of the first AND gate;
a first input terminal of the first AND gate is connected to a third output terminal of the detector;
a second input terminal of the first AND gate is connected to the controller;
a first output terminal and a second output terminal of the first oscillator are connected to a fourth input terminal and a fifth input terminal of the first AND gate;
a third output terminal of the first oscillator is connected to the controller;
a first input terminal of the first OR gate is connected to the controller;
an output terminal of the first AND gate is connected to a second input terminal of the first OR gate;
an output terminal of the first OR gate is connected to the signal input terminal of the millimeter wave transmitter;
an enable terminal of the controller is connected to the transmitting enable terminal of the millimeter wave transmitter; and
the output terminal of the fourth low dropout linear regulator circuit is connected to the transmitting power supply terminal of the millimeter wave transmitter.

16. The switching power supply according to claim 15, wherein the output control circuit comprises a first transistor, a second electrolytic capacitor, a fifth resistor, a third capacitor, a fourth capacitor, a sixth resistor, a seventh resistor, and an eighth resistor;
the secondary side of the transformer comprises a third winding;
a homonymous terminal of the third winding is respectively connected to one end of the second electrolytic capacitor, one end of the sixth resistor, the first input terminal of the detector, and the input terminal of the fourth low dropout linear regulator circuit;
the other end of the second electrolytic capacitor is respectively connected to a source of the first transistor, one end of the third capacitor, one end of the fourth capacitor, and one end of the eighth resistor, all of which are grounded;
the other end of the sixth resistor is respectively connected to one end of the seventh resistor and the positive terminal of the second comparator;
the other end of the seventh resistor is respectively connected to the other end of the eighth resistor and the positive terminal of the second comparator;
the other end of the third capacitor is respectively connected to the output terminal of the voltage regulator and the positive terminal of the Schmitt trigger;
the other end of the fourth capacitor is connected to the output terminal of the fourth low dropout linear regulator circuit;
a heteronymous terminal of the third winding is respectively connected to a drain of the first transistor and one end of the fifth resistor; and
a source of the first transistor is connected to the controller via a second
the other end of the fifth resistor is connected to the second input terminal of the detector.

17. The switching power supply according to claim 16, wherein the secondary-side control circuit further comprises a charging protocol circuit; and
the controller is connected to the charging protocol circuit.

18. The switching power supply according to claim 17, wherein the charging protocol circuit further comprises a digital controller and a USB PD controller;
the sixth resistor and the seventh resistor in the output control circuit are replaced by a second transistor and a fifth capacitor;
a drain of the second transistor is respectively connected to the one end of the second electrolytic capacitor, the first input terminal of the voltage regulator, and the input terminal of the fourth low dropout linear regulator circuit;
a source of the second transistor is respectively connected to one end of the fifth capacitor and the USB PD controller;
a gate of the second transistor is connected to a first output terminal of the digital controller;
the other end of the fifth capacitor is connected to the other end of the eighth resistor;
an input terminal of the digital controller is connected to the first input terminal of the detector;
a second output terminal of the digital controller is connected to the positive terminal of the second comparator;
the USB PD controller is respectively connected to the first input terminal of the detector and the output terminal of the fourth low dropout linear regulator circuit; and
control lines of the digital controller and the USB PD controller are connected in sequence.

19. The switching power supply according to claim 11, wherein the logic control and fault protection circuit comprises a fourth comparator, a first fault manager, a second AND gate, a second OR gate, a second oscillator, a first power manager, a fifth comparator, a sixth comparator, and a third transistor;
the output terminal of the AC overvoltage protection circuit is connected to a positive terminal of the fourth comparator;
a first output terminal of the first power manager is connected to a negative terminal of the fourth comparator;
an output terminal of the fourth comparator is connected to a first input terminal of the first fault manager;
the output terminal of the brown-in/brown-out protection circuit is connected to a second input terminal of the first fault manager;
the output terminal of the VCC overvoltage protection circuit is connected to a third input terminal of the first fault manager;
a fourth input terminal of the first fault manager is connected to an output terminal of an internal overtemperature protection circuit;
an output terminal of the first fault manager, after inversion, is connected to a first input terminal of the second AND gate;
the output terminal of the first low dropout linear regulator circuit is connected to a first input terminal of the first power manager;
a second input terminal of the first power manager is connected to an output terminal of a soft-start circuit;
a second output terminal of the first power manager is connected to the negative terminal of a fifth comparator;
a third output terminal of the first power manager is connected to a negative terminal of the sixth comparator;
a fourth output terminal of the first power manager is connected to the first input terminal of the third low dropout linear regulator circuit;
a fifth output terminal of the first power manager is connected to the negative terminal of the first comparator;
a positive terminal of the fifth comparator is connected to the signal output terminal of the millimeter wave receiver via the first buffer;
an output terminal of the fifth comparator is connected to a second input terminal of the second AND gate;
a positive terminal of the sixth comparator receives a DC voltage;
an output terminal of the sixth comparator is connected to the receiving enable terminal of the millimeter wave receiver;
an input terminal of the second oscillator is connected to the output terminal of the maximum frequency setting circuit;
an output terminal of the second oscillator is connected to a third input terminal of the second AND gate;
an output terminal of the second AND gate is connected to the S terminal of the RS flip-flop;
a first input terminal of the second OR gate is connected to a maximum on-time setting circuit;
a second input terminal of the second OR gate is connected to the output terminal of the first comparator;
an output terminal of the second OR gate is connected to the R terminal of the RS flip-flop;
the output terminal of the X capacitor discharge circuit is connected to a gate of the third transistor;
a drain of the third transistor is connected to an AC input; and
a source of the third transistor is grounded.

20. The switching power supply according to claim 16, wherein the controller comprises a seventh comparator, a second power manager, an SR drive signal manager, a second fault manager, an SR enable circuit, and a pulse frequency modulator;
the output terminal of the LATCH/auto recovery circuit is connected to an input terminal of the second power manager;
a second input terminal of the second power manager is connected to a negative terminal of the seventh comparator;
the other end of the sixth resistor is connected to a positive terminal of the seventh comparator;
an output terminal of the seventh comparator is connected to the transmitting enable terminal of the millimeter wave transmitter;
a second output terminal of the external overtemperature protection circuit, the output terminal of the Schmitt trigger, and the output terminal of the LATCH/auto recovery circuit are all connected to an input terminal of the second fault manager;
an output terminal of the second fault manager, an output terminal of the pulse frequency modulator, a second output terminal of the detector, and the third output terminal of the first oscillator are all connected to an input terminal of the SR drive signal manager;
a first output terminal of the SR drive signal manager is connected to an input terminal of the second buffer;
a second output terminal of the SR drive signal manager is connected to the first input terminal of the first OR gate;
a third output terminal of the SR drive signal manager is connected to an input terminal of the SR enable circuit; and
an output terminal of the SR enable circuit is connected to the second input terminal of the first AND gate.

21. The switching power supply according to claim 17, wherein the synchronous rectification circuit is a synchronous rectification chip, and the charging protocol circuit is a charging protocol chip.

22. The switching power supply according to claim 21, wherein the synchronous rectification circuit and the charging protocol circuit are respectively integrated in the controller.

23. The switching power supply according to claim 22, wherein a plurality of the charging protocol circuits are integrated in the controller.
